(19) United States
(12) Patent Application Publication
(10) Pub. No.: US 2006/0164334 A1
(43) Pub. Date: Jul. 27, 2006

(54) Plasma display and driving method thereof

(76) Inventor: Joo-Yul Lee, Suwon-si (KR)

Correspondence Address: CHRISTIE, PARKER & HALE, LLP, PO BOX 7068, PASADENA, CA, 91109-7068, US

(21) Appl. No.: 11/180,097

(22) Filed: Jul. 12, 2005

(30) Foreign Application Priority Data
Jan. 25, 2005 (KR) 10-2005-0006608

(51) Int. Cl. G09G 3/28

(52) U.S. Cl. 345/60

(57) ABSTRACT

In a plasma display, a driving waveform for a reset discharge, an address discharge, and a sustain discharge is applied to a Y electrode, and an X electrode is biased at a constant voltage. All cells are set to turn-on cells in the reset period, and turn-off cells are selected among the turn-on cells through the address discharge. The turn-on cells not having undergone the address discharge are sustain-discharged in the sustain period.

### CROSS-REFERENCE TO RELATED APPLICATION

This application claims priority to and the benefit of Korean Patent Application No. 10-2005-0006608 filed in the Korean Intellectual Property Office on Jan. 25, 2005, the entire content of which is incorporated herein by reference.

### BACKGROUND OF THE INVENTION

1. Field of the Invention

The present invention relates to a plasma display and a driving method thereof.

2. Description of the Related Art

A plasma display is a display device that uses plasma generated by gas discharge in discharge cells to display characters or images. Depending on its size, a plasma display panel (PDP) of the plasma display includes more than several tens to millions of pixels arranged in a matrix pattern.

One frame of the plasma display is divided into a plurality of subfields, and each subfield includes: a reset period, an address period, and a sustain period. The reset period is for initializing the status of each discharge cell so as to facilitate an addressing operation on the discharge cell. The address period is for selecting turn-on/turn-off cells among the discharge cells, and the sustain period is for causing the turn-on cells to continue discharge for displaying an image.

In order to perform the above operations and to display an image, sustain pulses are alternately applied to scan electrodes and sustain electrodes during the sustain period, and reset waveforms and address waveforms are applied to the scan electrodes during the reset period and the address period. Therefore, a scan driving board for driving the scan electrodes and a sustain driving board for driving the sustain electrodes are separately needed. Mounting the two separate driving boards on a chassis base may generate problems and increase the overall cost of the device. In addition, since the scan driving board supplies driving waveforms of the reset period and the address period, the magnitude of the impedance component formed on the scan driving board is different from that formed on the sustain driving board. Accordingly, the waveform of the sustain pulse applied to the scan electrode is different from that applied to the sustain electrode in the sustain period.

Therefore, for combining the two driving boards into a single combined board, schemes of coupling the single combined board to the scan electrodes and extending the sustain electrodes to reach the combined board have been proposed. However, when the two driving boards are combined as such, the impedance component created at the extended sustain electrodes is increased. As a result, a distortion is generated in the sustain pulse.

### SUMMARY OF THE INVENTION

The present invention provides a plasma display and a driving method thereof for preventing distortion of a sustain pulse. The present invention also provides a plasma display for reducing or eliminating a driving board for driving a sustain electrode.

An exemplary embodiment of the present invention discloses a driving method of a plasma display. The plasma display includes: a first electrode, a second electrode, a third electrode which extends substantially perpendicular to the first and second electrodes, and a cell. The cell corresponds to an intersection of the first, second, and third electrodes. The driving method includes: gradually reducing a voltage of the first electrode from a first voltage to a second voltage; applying a scan pulse and an address pulse to the first and third electrodes of a cell, respectively, to set the cell receiving the scan pulse and the address pulse to a turn-off cell; and applying a sustain pulse alternatively having a third voltage lower than a fourth voltage and a fifth voltage higher than the fourth voltage to the first electrode while applying the fourth voltage to the second electrode.

Another exemplary embodiment of the present invention discloses a plasma display. The plasma display includes: a PDP, a controller, and a driver. The PDP includes: a plurality of first electrodes, a plurality of second electrodes, a plurality of third electrodes, and a plurality of cells, the third electrode extending substantially perpendicular to the first and second electrodes, the cell corresponding to an intersection of the first electrode, the second electrode and the third electrode. The controller controls the driving of the PDP. The driver performs an address period for discharging cells to be set to turn-off cells among a plurality of turn-on cells, and performs a sustain period for applying a sustain pulse to the first electrodes to sustain-discharge turn-on cells while applying a first voltage to the second electrodes.

Still another exemplary embodiment of the present invention discloses a driving method of a plasma display. The plasma display includes: a plurality of first electrodes, a plurality of second electrodes, a plurality of third electrodes and a plurality of cells, and displays an image during a frame. The third electrode extends substantially perpendicular to the first and second electrodes. The cell is formed by the first, second, and third electrodes, and the frame is divided into a plurality subfields. In a first subfield, the driving method includes: initializing the plurality of cells to turn-on cells; discharging cells to be set to turn-off cells among the plurality of cells; and applying sustain pulses to the first electrodes to sustain-discharge turn-on cells while applying a first voltage to the second electrodes. In a second subfield subsequent to the first subfield, the driving method includes: discharging cells to be set to turn-off cells among the cells sustain-discharged in the first subfield; and applying the sustain pulses to the first electrodes to sustain-discharge the turn-on cells while applying the first voltage to the second electrodes.

A driving method of a plasma display is disclosed in further another exemplary embodiment including: gradually reducing the voltage of the first electrodes from a first voltage to a second voltage; selecting turn-off cells or turn-on cells among the plurality of cells through address discharge; and applying a sustain pulse alternatively having a third voltage lower than a fourth voltage and a fifth voltage higher than the fourth voltage to the first electrodes while applying the fourth voltage to the second electrodes.

A plasma display disclosed in a yet further exemplary embodiment includes: a PDP, a chassis base, a control board, and a driving board. The PDP includes: a plurality of first electrodes, a plurality of second electrodes, a plurality of third electrodes, and a plurality of cells, the third electrode extending substantially perpendicular to the first and second electrodes, the cell corresponding to an intersection of the first electrode, the second electrode and the third electrode. The chassis base is opposite to the PDP. The control board is formed on the chassis base and divides a frame for displaying an image into a plurality of subfields. The driving board is formed on the chassis base, applies a driving waveform displaying the image on the PDP to the first and third electrodes, biases the second electrodes at a first voltage, and performs an address period for address-discharging cells to be set to turn-off cells among turn-on cells and a sustain period for sustain-discharging turn-on cells, in the respective subfields.

A still further exemplary embodiment discloses a plasma display including a PDP, a chassis base, a control board, and first and second driving boards. The PDP includes: a plurality of first electrodes, a plurality of second electrodes, a plurality of third electrodes, and the third electrode extends substantially perpendicular to the first and second electrodes. The chassis base is opposite an image display side of the PDP and biases the second electrodes at a constant voltage. The first and second driving boards are formed on the chassis base, and apply first and second driving waveforms displaying the image to the first and second electrodes, respectively. The control board is formed on the chassis base, and controls the first and second driving boards. No driving board for driving the second electrodes by control of the control board is formed on the chassis base.

### BRIEF DESCRIPTION OF THE DRAWINGS

FIG. 1 shows an exploded perspective view of a plasma display according to an exemplary embodiment of the present invention.

FIG. 2 shows a schematic view of a plasma display panel according to an exemplary embodiment of the present invention.

FIG. 3 shows a plan view of a chassis base of a plasma display according to an exemplary embodiment of the present invention.

FIG. 4 shows a driving waveform of the plasma display according to a first exemplary embodiment of the present invention.

FIG. 5 shows the wall charge state of a cell after a reset period ends.

FIG. 6 shows a driving waveform of the plasma display according to a second exemplary embodiment of the present invention.

FIG. 7A, FIG. 7B, FIG. 7C, and FIG. 7D show the wall charge conditions of a cell according to the driving waveforms of FIG. 6, respectively.

FIG. 8 shows a driving waveform of the plasma display according to a third exemplary embodiment of the present invention.

FIG. 9 shows a driving method of the plasma display according to a third exemplary embodiment of the present invention.

FIG. 10 shows a driving waveform of the plasma display according to a fourth exemplary embodiment of the present invention.

### DETAILED DESCRIPTION

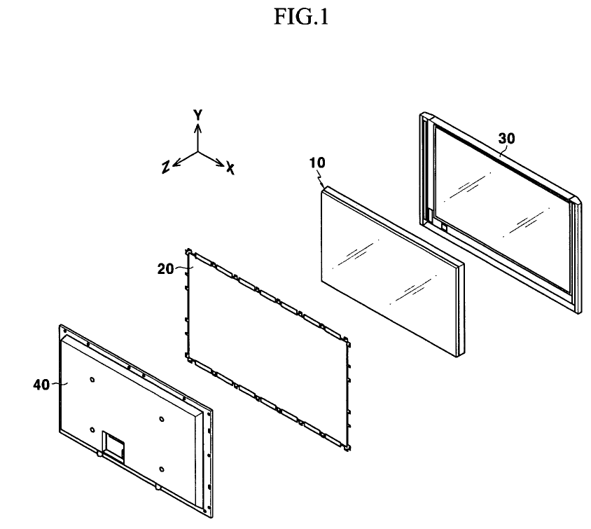

Referring now to FIGS. 1, 2 and 3, the plasma display includes: a PDP 10, a chassis base 20, a front case 30, and a rear case 40. The chassis base 20 is coupled to the plasma display panel 10 opposite an image display side of the plasma display panel 10. The front case 30 is coupled to the plasma display panel 10 on the image display side of the plasma display panel 10. The rear case 40 is coupled to the chassis base 20. The assembly of these parts forms a plasma display.

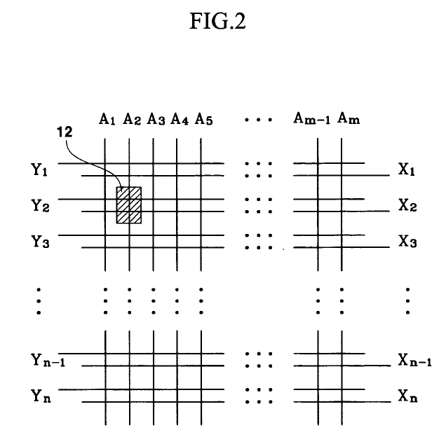

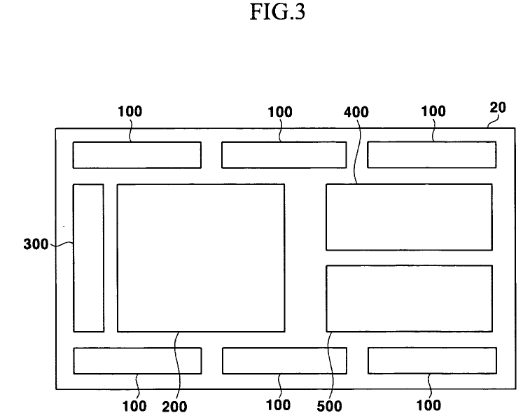

As shown in FIG. 2, the PDP 10 of FIG. 1 includes: a plurality of address (A) electrodes A1 to Am extending in a column direction, and a plurality of scan (Y) electrodes Y1 to Yn and a plurality of sustain (X) electrodes X1 to Xn each extending in a row direction. The respective sustain electrodes X1 to Xn correspond to the respective scan electrodes Y1 to Yn. The sub-pixel area delineating a discharge space where the A electrodes cross the Y and X electrodes forms a discharge cell 12.

As shown in FIG. 3, driving boards 100, 200, 300, 400, 500 for driving the PDP 10 are formed on the chassis base 20. Address buffer boards 100 are formed on a top and a bottom of the chassis base 20. The configuration shown is considered a dual driving scheme, providing address voltages from both top and bottom sides of the chassis 20, and may be altered depending on the driving scheme. For example, in a single driving scheme, the address buffer boards 100 may be located on either the top or the bottom of the chassis base 20. Further, the address buffer board 100 may be formed as a single board or a combination of a plurality of boards.

The address buffer board 100 receives an address driving control signal from a control board 400 and applies a voltage for selecting a turn-on cell (or a turn-off cell) to the appropriate A electrodes. The X electrodes are biased at a constant reference voltage.

A scan driving board 200 is located to the left of the chassis base 20 and is coupled to the Y electrodes through a scan buffer board 300. During an address period, the scan buffer board 300 applies a voltage to the Y electrodes for sequentially selecting scan electrodes Y1 to Yn. The scan driving board 200 receives a driving signal from the control board 400 and applies a driving voltage to the Y electrodes. While, in FIG. 3, the scan driving board 200 and the scan buffer board 300 are shown on the left side of the chassis base 20, they may be located on the right side of the chassis base 20. Also, the scan buffer board 300 and the scan driving board 200 may be combined together as one integral part.

Upon receiving an external image signal, the control board 400 generates a control signal for driving the A electrodes and a control signal for driving the Y and X electrodes. The control board 400 subsequently applies the control signals to the address buffer board 100, the scan driving board 200, and the scan buffer board 300. A power supply board 500 supplies the power for driving the plasma display. The control board 400 and the power supply board 500 are located on a central area of the chassis base 20.

The address buffer board 100, the scan driving board 200 and the scan buffer board 300 are operated as a driver of the PDP 10. The control board 400 is operated as a controller of the PDP 10. The power supply board 500 is operated as a power source of the PDP 10.

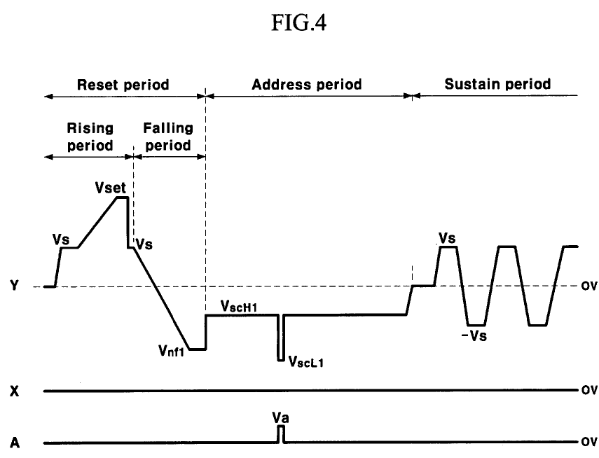

FIG. 4 shows a driving waveform of the plasma display according to a first exemplary embodiment of the present invention. For convenience of description, driving waveforms applied to a Y electrode, an X electrode, and an A electrode are exemplarily described in connection with only one cell 12 (FIG. 2). In the driving waveform shown in FIG. 4, and referring to FIG. 3, the Y electrode receives a voltage from the scan driving board 200 and the scan buffer board 300, and the A electrode receives a voltage from the address buffer board 100. The X electrode is biased at the constant reference voltage, represented as a ground voltage (0V) in FIG. 4.

As explained above, the plasma display is driven during frames and frames are divided into subfields. As shown in FIG. 4, one subfield of the driving waveform is divided into three periods, the reset period, the address period, and the sustain period. The reset period has a rising period and a falling period.

During the rising period of the reset period, the voltage of the Y electrode is gradually increased from a voltage Vs to a voltage Vset while the A electrode is maintained at a reference voltage 0V. The voltage of the Y electrode increases in a ramp between voltage Vs and voltage Vset. As the voltage of the Y electrode is increased, a weak discharge is generated between the Y and X electrodes and between Y and A electrodes, and (−) wall charges are formed on the Y electrode and (+) wall charges are formed on the X and A electrodes. In addition, when the voltage of the Y electrode changes gradually, as shown in FIG. 4, a weak discharge is caused in a cell 12 (FIG. 2), and accordingly, wall charges are formed such that a sum of an externally applied voltage and a wall voltage may be maintained at a discharge firing voltage. The above-described scheme is disclosed in U.S. Pat. No. 5,745,086 by Weber.

Wall charges being described in the present invention refer to charges formed on a wall of a discharge cell 12 (FIG. 2) close to each electrode (X, Y, or A) and accumulated on the electrode. The wall charge is described as being “formed” or “accumulated” on the electrode (X, Y, or A) although the wall charges do not actually touch the electrodes. Further, a wall voltage Vw means a potential difference formed between the walls of the discharge cell 12 (FIG. 2) by the wall charges.

The voltage Vset is a voltage high enough to fire a discharge in cells 12 of any condition because every cell 12 (FIG. 2) has to be initialized during the reset period. Generally, the voltage Vs is equal to the voltage applied to the Y electrode during the sustain period, and is less than a voltage required for firing discharge between the Y electrode and X electrode.

During the falling period of the reset period, the voltage of the Y electrode is gradually reduced from the voltage Vs to a voltage Vnf1 while the voltage of the A electrode is maintained at the reference voltage. As a result, a weak discharge is generated between the Y and X electrodes and between the Y and A electrodes while the voltage of the Y electrode is reduced, and accordingly, the (−) wall charges formed on the Y electrode and the (+) wall charges formed on the X and A electrodes are eliminated. The voltage Vnf1 is set to be close to a discharge firing voltage between the Y and X electrodes. Then, a wall voltage between the Y and X electrodes reaches near 0V, and therefore, a cell 12 (FIG. 2) that was not addressed with an address discharge during the address period may be prevented from misfiring during the sustain period. The wall voltage between the Y and A electrodes is determined by the magnitude of Vnf1 because the voltage of the A electrode is maintained at the reference voltage 0V.

Subsequently, during the address period for selecting turn-on cells 12, a scan pulse VscL1 and an address pulse Va are applied to the Y electrode and the A electrode of the turn-on cell 12 (FIG. 2), respectively. A non-selected Y electrode is biased at a voltage VscH which is higher than VscL1, and the reference voltage is applied to the A electrode of the cell being turned off. The scan buffer board 300 selects a Y electrode to be applied with the scan pulse of VscL1, among the scan electrodes Y1 to Yn. For example, in the single driving method, the Y electrodes may be selected in an order of arrangement of the Y electrodes in the column direction. When a Y electrode is selected, the address buffer board 100 selects cells 12 to be turned on among the cells along the selected Y electrode. That is, the address buffer board 100 selects the A electrodes to which the address pulse of the voltage Va is applied among the address electrodes A1 to Am.

The scan pulse, in the form of the voltage VscL1, is first applied to the Y electrode in the first row (Y1). At the same time, the address pulse, in the form of the voltage Va, is applied to the A electrode on the cells 12 to be turned on along the first row. Then, after a discharge is generated between the Y electrode in the first row (Y1) and the A electrode receiving the voltage Va, a discharge is generated between the Y electrode and the X electrode. Accordingly, (+) wall charges are formed on the Y electrode and (−) wall charges are formed on the A electrode and X electrode. As a result, a wall voltage Vwxy1 is formed between the X and Y electrodes with the potential of the wall adjacent the Y electrode higher than the potential of the wall adjacent the X electrode. Subsequently, while the scan voltage, in the form of the voltage VscL1, is applied to the Y electrode in a second row (Y2), the address pulse, in the form of the voltage Va, is applied to the A electrodes in cells 12 to be turned on along the second row. Then, the address discharge is generated in the cells 12 crossed by the A electrodes receiving the voltage Va and the Y electrode in the second row (Y2) and accordingly, wall charges are formed in those cells 12 in the manner described above. Regarding Y electrodes in other rows, wall charges are formed in cells 12 to be turned on in the same manner as described above, i.e., by applying the address pulse, the voltage Va, to A electrodes on cells to be turned on 12 while sequentially applying a scan pulse, voltage VscL1, to the Y electrodes from the first row (Y1) to the last row (Yn).

During the address period described above, the voltage VscL1 is usually set to be equal to or lower than the voltage Vnf1, and the voltage Va is usually set to be higher than the reference voltage. Generation of address discharge by applying the voltage Va to the A electrode will now be described in connection with the case that the voltage VscL1 equals the voltage Vnf1. When the voltage Vnf1 is applied in the reset period, a sum of the wall voltage between the A and Y electrodes and the external voltage Vnf1 between the A and the Y electrodes reaches the discharge firing voltage Vfay between the A and Y electrodes. For example, when 0V is applied to the A electrode and the voltage VscL1, that is equal to Vnf1 in this case, is applied to the Y electrode in the address period, the voltage Vfay is formed between the A and Y electrodes, and accordingly generation of a discharge may be expected. However, in this case, the expected discharge is not generated because a discharge delay is greater than the width of the scan pulse and the address pulse. However, if the voltage Va is applied to the A electrode and the voltage VscL1=Vnf1 is applied to the Y electrode, a voltage greater than the firing voltage Vfay is formed between the A and Y electrodes, and accordingly, the discharge delay is reduced to less than the width of the scan pulse, allowing a discharge to be generated. The voltage difference between the electrodes A and Y is increased as the magnitudes of Va and VscL1 are increased, because Va is positive and VscL1 is negative and an increase in their magnitudes means a greater voltage difference between them. Similarly, generation of the address discharge may be facilitated by setting the voltage VscL1 to be lower than the voltage Vnf1.

Subsequently, during the sustain period, a sustain discharge is generated between the Y and X electrodes by initially applying a pulse, in the form of the voltage Vs, to the Y electrode. Just before the application of this voltage, the wall voltage Vwxy1 is formed such that the potential of the Y electrode is higher than the X electrode in the cells 12 having undergone the address discharge in the address period. During the sustain period, the voltage Vs is set to be lower than the discharge firing voltage Vfxy, while the sum of the voltages Vs+Vwxy1 is set to be higher than the voltage Vfxy. In this manner, the positive wall voltage Vwxy1, from the Y electrode to the X electrode, existing before the application of Vs does not generate a discharge. At the same time, once Vs arrives, the sum of these two generally positive voltages will reach above the required firing voltage discharge between X and Y electrodes and a discharge is sustained.

As a result of the sustain discharge, the (−) wall charges are formed on the Y electrode and the (+) wall charges are formed on the X and A electrodes, such that the potential of the X electrode wall is higher than the Y electrode wall. Because the voltage Vwyx1 is formed such that the potential of the Y electrode itself, and not its adjacent wall, becomes higher than the X electrode itself, a pulse of a negative voltage −Vs is applied to the Y electrode to fire a subsequent sustain discharge. As a result of this discharge, once again (+) wall charges are formed on the Y electrode and (−) wall charges are formed on the X and A electrodes such that another sustain discharge may be generated by applying the positive voltage Vs to the Y electrode.

The process of alternately applying the sustain pulses of Vs and −Vs to the Y electrode is repeated a number of times corresponding to a weight value of a corresponding subfield.

As described above, according to the first embodiment of the present invention shown in FIG. 4, reset, address, and sustain operations may be performed by a driving waveform applied only to the Y electrode while the X electrode is biased at the reference voltage. Accordingly, a driving board for driving the X electrode is not required and the X electrode may stay simply biased at a reference voltage, for example at 0V. Since the sustain pulses are only supplied from the scan driving board 200, the impedance formed by the voltage Vs applied to the Y electrode is substantially same as that by the voltage −Vs applied to the Y electrode.

In addition, as an alternative to the first embodiment of the present invention shown in FIG. 4, a constant positive voltage may be applied to the X electrode during the falling period of the reset period and the address period. Then, since a sustain driving board which only has an element for transmitting the constant positive voltage is formed on the chassis base 20, the sustain driving board can be minimized.

Furthermore, while the rising start voltage of the Y electrode of the rising period and the falling start voltage of the Y electrode of the falling period are respectively set to the voltage Vs in the first exemplary embodiment of the present invention, another voltage may be used for the rising start voltage or the falling start voltage. If the discharge of the cells starts in the rising period when the voltage of the Y electrode is a voltage higher than the voltage Vs, the rising start voltage of the Y electrode may be set to the voltage higher than the voltage Vs. Then, the rising period will be shorter. In the same manner, if the discharge of the cells starts in the falling period when the voltage of the Y electrode is a voltage lower than the voltage Vs, the falling start voltage of the Y electrode may be set to the voltage lower than the voltage Vs. Then, the falling period will be shorter. In addition, a voltage lower than the voltage Vs may be used for the rising start voltage, and a voltage higher than the voltage Vs may be used for the falling start voltage.

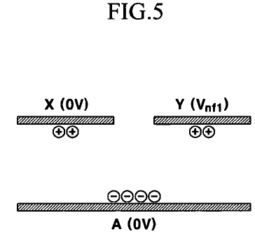

Referring again to FIG. 4, according to the first exemplary embodiment the final voltage Vnf1, that is a voltage applied to the Y electrode during the falling period of the reset period, may be near the discharge firing voltage, Vfxy, between the Y and X electrodes. If the discharge firing voltage Vfay between the Y and A electrodes is less than discharge firing voltage Vfxy between the Y and X electrodes, the (+) wall charges will be formed on the Y electrode and the (−) wall charge will be formed on the A electrode at the final voltage Vnf of the falling period, as shown in FIG. 5. That is, a wall potential of the Y electrode with respect to the A electrode may be a positive voltage at the final voltage Vnf of the falling period.

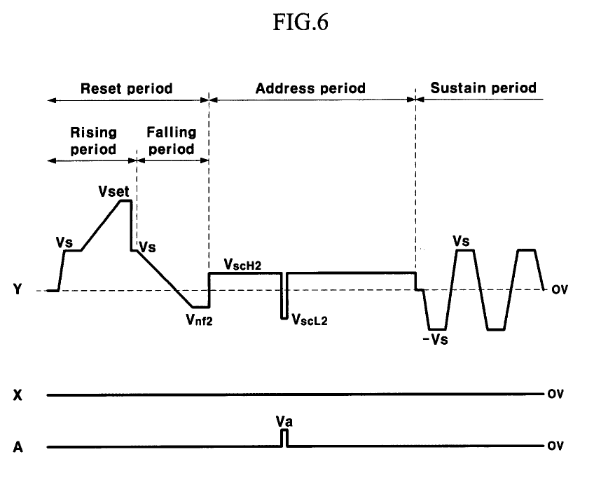

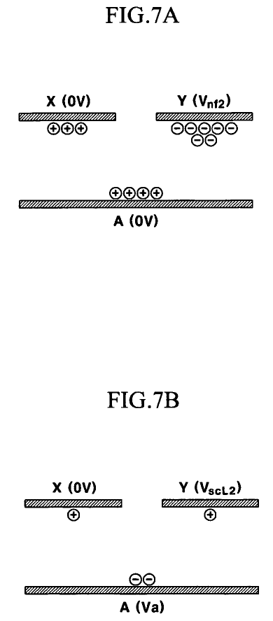

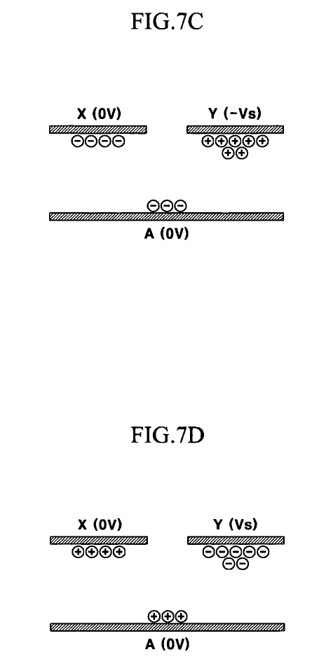

In the state of cell shown in FIG. 5, if the voltage Vs is applied to the Y electrode in the sustain period, the discharge may be generated between the Y and A electrodes by a difference between external voltages applied to the Y and A electrodes and a wall voltage between the Y and A electrodes. That is, the turn-off cell may be discharged in the sustain period. An exemplary embodiment for preventing this misfiring discharge will be described with reference to FIG. 6 and FIGS. 7A to 7D.

FIG. 6 shows a driving waveform of the plasma display according to a second exemplary embodiment of the present invention, and FIGS. 7A to 7D respectively shows wall charge conditions of a cell according to the driving waveforms of FIG. 6. FIG. 7A shows the wall charge condition of the cell at the time that the falling period of the reset period ends. FIG. 7B shows the wall charge condition of the cell at the time after an address discharge is generated in the cell. FIG. 7C shows the wall charge condition of the cell at the time after a first sustain-discharge is generated in the cell. FIG. 7D shows the wall charge condition of the cell at the time after a second sustain-discharge is generated in the cell.

As shown in FIG. 6, the driving waveform according to the second exemplary embodiment of the present invention is similar to the first exemplary embodiment. However, the voltage of Y electrode is gradually reduced from the voltage Vs to the voltage Vnf2 higher than the voltage Vnf1. Herein, when the voltage of the Y electrode reaches the voltage Vnf2, a predetermined amount of the (−) wall charges are remained on the Y electrode and a predetermined amount of the (+) wall charges are remained on the X and A electrodes as shown in FIG. 7A. Then, the wall voltage Vwxy2 which is formed between the Y and X electrodes with the potential of the wall adjacent the X electrode higher than the potential of the wall adjacent the Y electrode is given by Equation 1 below.
Vwxy2=Vfxy+Vnf2 [Equation 1]

In addition, the voltage Vnf2 is set such that a sum of the wall voltage Vwxy2 and the voltage Vs is higher than the discharge firing voltage Vfxy between the X and Y electrodes as expressed in Equation 2 below.
Vfxy<Vwxy2+Vs=Vfxy+Vnf2+Vs [Equation 2]

Accordingly, the voltage Vnf2 is set to be higher than the voltage −Vs as expressed in Equation 3 below
Vnf2>−Vs [Equation 3]
Then, the all cells are set to the turn-on cells in the reset period. That is, when the voltage −Vs is applied to the Y electrode in the sustain period, the sustain-discharge is generated in the cell on which the wall voltage Vwxy2 is formed.

Subsequently, during the address period, a scan pulse VscL2 and an address pulse Va are applied to the Y electrode and the A electrode of the turn-off cell 12 (FIG. 2), respectively. Then, an address discharge is generated between the Y electrode receiving the voltage VscL2 and the A electrode receiving the voltage Va. Accordingly, wall charges formed on the Y, X, and A electrode of the cell are eliminated as shown in FIG. 7B. That is, due to a discharge between the Y and A electrodes following a discharge between the Y and A electrodes, the wall charges formed on the Y, X, and A electrode of the cell so that the cell is set to the turn-off cell. In addition, a non-selected Y electrode is biased at the voltage VscH which is higher than the voltage VscL2, and the reference voltage is applied to the A electrode of the cell being turned on. Then, the turn-on cell not having undergone the address discharge maintains the state shown in FIG. 7A.

Subsequently, during the sustain period, a pulse, in the form of the voltage −Vs, is initially applied to the Y electrode since the potential of the X electrode wall is higher than the Y electrode wall in the turn-on cells not having undergone the address discharge in the address period. Since the wall voltage Vwxy2 is set to satisfy Equation 2, the sustain-discharge is generated between the X and Y electrodes of the turn-on cell such that the (−) wall charges are formed on the X electrode and the (+) wall charges are formed on the Y electrode as shown in FIG. 7C.

Herein, the misfiring discharge is not generated between the Y and A electrodes when the voltage −Vs or Vs is applied to the Y electrode because the wall charges formed on the Y and A electrodes are almost eliminated in the turn-off cells having undergone the address discharge in the address period.

As a result of the sustain discharge, the (+) wall charges are formed on the Y electrode and the (−) wall charges are formed on the X electrode, such that the potential of the Y electrode wall is higher than the X electrode wall. Therefore, a pulse of a voltage Vs is applied to the Y electrode to fire a subsequent sustain discharge. As a result of this discharge, once again (−) wall charges are formed on the Y electrode and (+) wall charges are formed on the X and A electrode as shown in FIG. 7D such that another sustain discharge may be generated by applying the negative voltage −Vs to the Y electrode.

The process of alternately applying the sustain pulses of −Vs and Vs to the Y electrode is repeated a number of times corresponding to a weight value of a corresponding subfield.

In the second embodiment of the present invention, the cell having undergone the address discharged is set to the turn-off cell in the address period. That is, since the address operation for eliminating the wall charges is performed in the address period, the final voltage Vnf2 of the reset period is set to higher than the voltage Vnf1 of the first exemplary embodiment. As a result, the misfiring discharge is not generated in the turn-off cell in the sustain period.

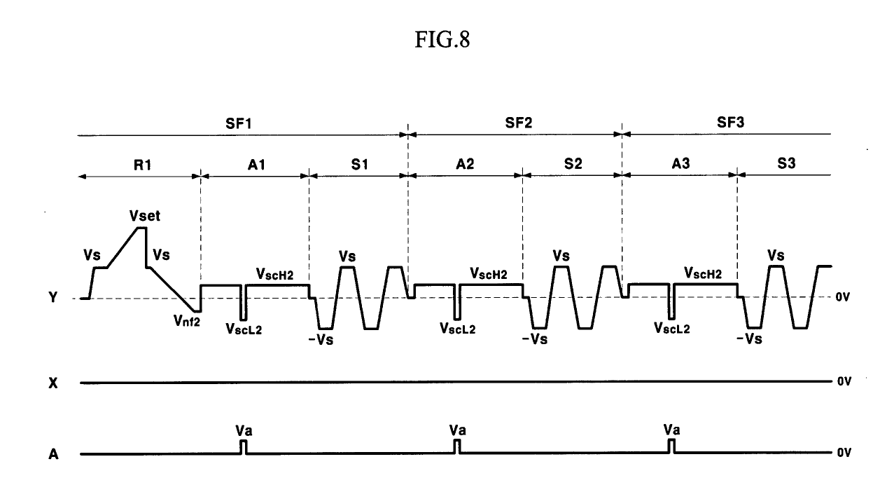

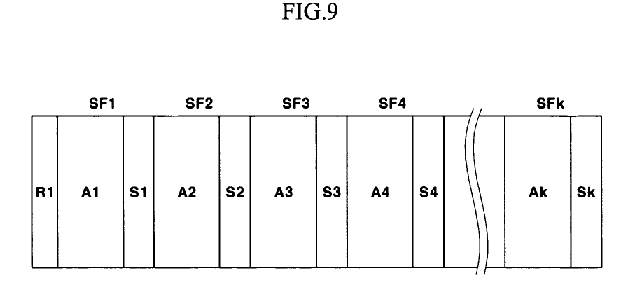

The waveform shown in FIG. 6 may be applied to the Y, X, and A electrodes in each of the plurality of subfields forming one frame. Then, the cell, which is turned off during one frame and represents 0 gray scale (black gray scale), becomes too bright. That is, since the weak discharge of the reset period and the address discharge of the address period are generated in the turn-off cell during the plurality of subfield forming one frame, the turn-off cell dose not represent the black color. An exemplary embodiment for minimizing the discharge of the turn-off cell will be described with reference to FIG. 8 and FIG. 9.

FIG. 8 shows a driving waveform of the plasma display according to a third exemplary embodiment of the present invention, and FIG. 9 shows a driving method of the plasma display according to a third exemplary embodiment of the present invention. The three subfields SF1, SF2, SF3 of the plurality of subfields are shown in FIG. 8, and the plurality of subfields SF1 to SFk forming one frame are shown in FIG. 9.

As shown in FIG. 8, the first subfield SF1 includes: the reset period R1, the address period A1, and the sustain period S1. The subfields SF2 and SF3 following the first subfield SF1 include the address period A2 and A3, and the sustain periods S2 and S3, respectively. The reset period R1, the address periods A1 to A3, and the sustain periods S1 to S3 respectively correspond to those described in the second exemplary embodiment, and the sustain period S1 to S3 end after the voltage Vs is applied to the Y electrode such that the last sustain-discharge is generated.

Then, the cell, which is set to the turn-off cell in the first subfield SF1 and has the cell state shown in FIG. 7B, is maintained to the turn-off cell in the subsequent subfields SF2 and SF3. That is, in the cell where the wall charges have been eliminated during the address period A1 of the first subfield SF1, the address discharge cannot be generated during the address periods A2 and A3 of the subsequent subfields SF2 and SF3.

In the end of the first subfield SF1, the turn-on cell has the cell state of FIG. 7D which is similar to the cell state of FIG. 7A, and therefore, the address discharge can be generated in this cell during the address period A2 of the subsequent subfield SF2. The address discharge is generated in the cell during the address period A2 of the second subfield SF2 such that this cell is set to the turn-off cell in the second subfield SF2 and does not sustain-discharge from the second subfield SF2. In addition, if the address discharge is not generated in the cell during the address period A2 of the second subfield SF2, this cell is set to the turn-on cell in the second subfield SF2 and can be set to the turn-off cell according to the address discharge in the subsequent subfield SF3.

As described above, in the subfield not having the reset period, the address discharge can be generated in the only cell which is set to the turn-on cell in the previous subfield. Therefore, if the first subfield is set to a subfield having the reset period and the remaining subfields are set to subfields not having the reset period in one frame, the discharge is generated during the reset period and the address period of the first subfield only when the 0 gray scale (black gray scale) is represented. That is, the contrast ratio can be improved since the discharge is not generated in the remained subfields when the black gray scale is represented.

In FIG. 9, assuming that the weights of all subfield are set to 1, the cell in which the address discharge is generated in the first subfield 1F represents 0 gray scale. Since the cell in which the address discharge is generated in the i^{th} subfield represents is set to the turn-on cell from the first subfield 1F to the (i-1)^{th} subfield, this cell represents (i-1) gray scale (where ‘i’ is an integer more than 1). Therefore, 0 to (k-1) gray scales are represented when one frame is divided into k subfields. However, since a period of one frame is limited, the number of the subfields forming one frame is limited, and therefore, the number of gray scales is limited. Therefore, the halftoning method such as a dithering method or an error diffusion method may be applied to the gray scales represented by a combination of the plurality of subfields so that the number of the gray scales increases.

While only one subfield having the reset period is used during one frame in FIG. 9, the plurality of subfields having the reset period may be formed in one frame.

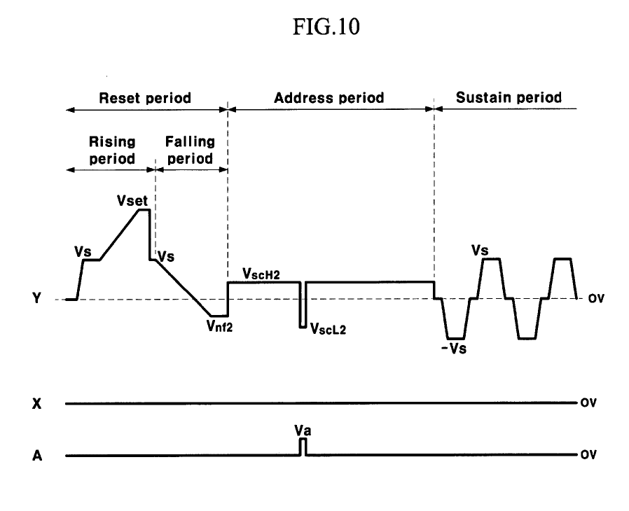

In the second and third exemplary embodiments, the voltage of the Y electrode is increased from the voltage Vs to the voltage −Vs and is reduced from the voltage −Vs to the voltage Vs during the sustain period. The electro magnetic interference (EMI) may be greatly generated by the voltage variance corresponding to 2Vs. In addition, the reactive power is consumed by the capacitance component formed by the X and Y electrodes. Since the reactive power is proportional to a square of the voltage variance 2Vs, i.e., (2Vs)² the reactive power consumption is high. An exemplary embodiment for not directly changing the voltage of Y electrode from the voltage −Vs to the voltage Vs will be described with reference to FIG. 10.

FIG. 10 shows driving waveforms of the plasma display according to a fourth exemplary embodiment of the present invention. The driving waveform according to the fourth exemplary embodiment is similar to the second exemplary embodiment. However, the voltage of the Y electrode is increased from 0V to the voltage Vs after rising from the voltage −Vs to 0V during the sustain period. In addition, the voltage of the Y electrode is reduced from 0V to the voltage −Vs after being reduced from the voltage Vs to 0V during the sustain period.

Then, the EMI can be reduced since the voltage variance of the Y electrode corresponds to the voltage Vs. Further, the reactive power is proportional to two times a square of the voltage variance, i.e., 2(Vs)². That is, the reactive power can be reduced to the half of the reactive power of the case where the voltage of the Y electrode is directly changed from the voltage −Vs to the voltage Vs.

The voltage of the Y electrode may be changed in two steps only when the voltage of the Y electrode is increased, or the voltage of the Y electrode may be changed in two steps only when the voltage of the Y electrode is reduced. In addition, the voltage of the Y electrode may be changed from the voltage −Vs to the voltage Vs through a voltage different from 0V, and may be changed in more than two steps.

While the voltage of the Y electrode has been described to be gradually changed in a ramp in the first to fourth exemplary embodiments, the voltage of the Y electrode may be gradually changed in the other form.

According to the exemplary embodiments of the present invention, the impedance on the path for applying the sustain pulse of the voltage Vs may be substantially same as the impedance on the path for applying the sustain pulse of the voltage −Vs because the sustain pulse is supplied from the scan driving board. In addition, a board for driving the X electrode may be eliminated because the X electrode is biased at the constant voltage. As a result, the cost for manufacturing the plasma display may be reduced.

Furthermore, the misfiring discharge of the sustain period may be prevented because the address discharge for eliminating the wall charges is generated in the address period.

While this invention has been described in connection with what is presently considered to be practical exemplary embodiments, it is to be understood that the invention is not limited to the disclosed embodiments, rather, is intended to cover various modifications and equivalent arrangements included within the spirit and scope of the appended claims.

What is claimed is:

1. A driving method of a plasma display, the plasma display including first electrodes, second electrodes, third electrodes, the third electrodes extending substantially perpendicular to the first electrodes and the second electrodes, and cells, each cell corresponding to an intersection of a respective first electrode, second electrode, and third electrode, the driving method comprising:
gradually reducing a voltage of the first electrode from a first voltage to a second voltage;
applying a scan pulse and an address pulse to the first electrode and the third electrode of a cell, respectively, to set the cell receiving the scan pulse and the address pulse to a turn-off cell;
applying a sustain pulse alternatively having a third voltage lower than a fourth voltage and a fifth voltage higher than the fourth voltage to the first electrode while applying the fourth voltage to the second electrode.

2. The driving method of claim 1, wherein the second voltage is higher than the third voltage.

3. The driving method of claim 2, wherein a difference between the fourth voltage and the third voltage is equal to a difference between the fifth voltage and the fourth voltage.

4. The driving method of claim 2, wherein the third voltage is initially applied to the first electrode when the sustain pulse is applied to the first electrode.

5. The driving method of claim 1, wherein the fourth voltage is applied to the second electrode while the voltage of the first electrode is gradually reduced and the scan pulse and the address pulse are respectively applied to the first electrode and the third electrode.

6. The driving method of claim 1, wherein the fourth voltage is a ground voltage.

7. The driving method of claim 1, further comprising gradually increasing the voltage of the first electrode from a sixth voltage to a seventh voltage before gradually reducing the voltage of the first electrode.

8. The driving method of claim 1, wherein the scan pulse has a voltage equal to or lower than the second voltage, and the address pulse has a voltage higher than the fourth voltage.

9. The driving method of claim 1, wherein at least one period of a period during which the voltage of the first electrode is increased from the third voltage to the fifth voltage and a period during which the voltage of the first electrode is reduced from the fifth voltage to the third voltage, includes a period during which the voltage of the first voltage is maintained at a sixth voltage between the third voltage and the fifth voltage.

10. The driving method of claim 1, further comprising:
applying the scan pulse and the address pulse to the first electrode and the third electrode of a cell which is set to a turn-on cell, respectively, to set the cell receiving the scan pulse and the address pulse to a turn-off cell;
applying the sustain pulse to the first electrode while applying the fourth voltage to the second electrode.

11. The driving method of claim 10, wherein a last discharge by the sustain pulse is generated when the fifth voltage is applied to the first electrode.

12. A plasma display comprising:
a plasma display panel including a plurality of first electrodes, a plurality of second electrodes, a plurality of third electrodes, the third electrodes extending substantially perpendicular to the first electrodes and the second electrodes, and a plurality of cells, each cell corresponding to an intersection of a respective first electrode, second electrode and the third electrode;
a controller for controlling driving of the plasma display panel; and
a driver for performing an address period for discharging cells to be set to turn-off cells among a plurality of turn-on cells, for performing a sustain period for applying a sustain pulse to the first electrodes to sustain-discharge turn-on cells while applying a first voltage to the second electrodes.

13. The plasma display of claim 12, wherein the driver further performs a reset period for initializing the states of the plurality of cells to the turn-on cells before performing the address period.

14. The plasma display of claim 13, wherein:
the sustain pulse alternatively has a second voltage lower than the first voltage and a third voltage higher than the first voltage, and
the driver gradually reduces the voltage of the first electrodes from a fourth voltage to a fifth voltage higher than the second voltage to initialize the plurality of cells during the reset period.

15. The plasma display of claim 14, wherein a difference between the first voltage and the second voltage is equal to a difference between the third voltage and the first voltage.

16. The plasma display of claim 14, wherein the driver respectively applies a scan pulse and an address pulse to the first electrode and the third electrode of the cell to be set to the turn-off cell.

17. The plasma display of claim 16, wherein a voltage of the scan pulse is equal to or lower than the fifth voltage, and a voltage of the address pulse is higher than the first voltage.

18. The plasma display of claim 13, wherein the driver applies the first voltage to the second electrodes during the reset and address periods.

19. The plasma display of claim 18, wherein the first voltage is a ground voltage.

20. A driving method of a plasma display for displaying an image during a frame, the frame being divided into a plurality of subfields, the plasma display including a plurality of first electrodes, a plurality of second electrodes, a plurality of third electrodes, the third electrodes extending substantially perpendicular to the first and second electrodes, and a plurality of cells, each cell corresponding to an intersection of a respective first electrode, second electrode, and third electrode, the driving method comprising:
in a first subfield,
initializing the plurality of cells to turn-on cells;
discharging cells to be set to turn-off cells among the plurality of cells; and
applying sustain pulses to the first electrodes to sustain-discharge turn-on cells while applying a first voltage to the second electrodes, and
in a second subfield subsequent to the first subfield,
discharging cells to be set to turn-off cells among the cells sustain-discharged in the first subfield; and
applying the sustain pulses to the first electrodes to sustain-discharge the turn-on cells while applying the first voltage to the second electrodes.

21. The driving method of claim 20, further comprising applying the first voltage to the second electrodes during initializing of the plurality of cells and discharging the cells to be set to the turn-off cells.

22. A driving method of a plasma display, the plasma display including a plurality of first electrodes, a plurality of second electrodes, a plurality of third electrodes, the third electrodes extending substantially perpendicular to the first and second electrodes, and a plurality of cells, each cell corresponding to an intersection of a respective first electrode, second electrode, and third electrode, the driving method comprising:
gradually reducing the voltage of the first electrodes from a first voltage to a second voltage;
selecting turn-off cells or turn-on cells among the plurality of cells through address discharge; and
applying a sustain pulse alternatively having a third voltage lower than a fourth voltage and a fifth voltage higher than the fourth voltage to the first electrodes while applying the fourth voltage to the second electrodes.

23. The driving method of claim 22, wherein the cell in which the address discharge is generated is set to the turn-off cell.

24. The driving method of claim 23, further comprising applying the fourth voltage to the second electrodes during gradually reducing the voltage of the first electrodes and selecting the turn-off cells or the turn-on cells.

25. A plasma display comprising:
a plasma display panel including a plurality of first electrodes, a plurality of second electrodes, a plurality of third electrodes, the third electrodes extending substantially perpendicular to the first and second electrodes, and a plurality of cells each cell corresponding to an intersection of a respective first electrode, second electrode and third electrode;
a chassis base opposite to the plasma display panel;
a control board formed on the chassis base for dividing a frame for displaying an image into a plurality of subfields; and
a driving board formed on the chassis base, for applying to the first electrodes and the third electrodes a driving waveform displaying the image on the plasma display panel, for biasing the second electrodes at a first voltage, and for performing an address period for address-discharging cells to be set to turn-off cells among turn-on cells and a sustain period for sustain-discharging turn-on cells, in the respective subfields.

26. The plasma display of claim 25, wherein the driving board further performs a reset period for initializing the plurality of cells to turn-on cells in a first subfield of the plurality of subfields.

27. The plasma display of claim 26, wherein the first subfield is positioned at the head of the frame.

28. The plasma display of claim 26, wherein the driving board address-discharges cells to be set to turn-off cells among the cells sustain-discharged in a previous subfield during the address period of second subfield.

29. The plasma display of claim 26, wherein the driving board gradually reduces a voltage of the first electrodes from a second voltage to a third voltage during the reset period, and applies a sustain pulse alternately having a fourth voltage lower than the third voltage and a fifth voltage higher than the first voltage to the first electrodes during the sustain period.

30. The plasma display of claim 29, wherein the driving board initially applies the fourth voltage to the first electrodes in the sustain period, and applies the fifth voltage to the first electrodes to perform a last sustain-discharge in the sustain period.

31. A plasma display comprising:
a plasma display panel including a plurality of first electrodes, a plurality of second electrodes, a plurality of third electrodes, the third electrodes extending substantially perpendicular to the first and second electrodes;
a chassis base opposite an image display side of the plasma display panel for biasing the second electrodes at a constant voltage;
a first driving board formed on the chassis base for applying a first driving waveform displaying the image on the plasma display panel to the first electrodes;
a second driving board formed on the chassis base for applying a second driving waveform displaying the image on the plasma display panel to the third electrodes; and
a control board formed on the chassis base for controlling the first and second driving boards,
wherein the chassis base is absent a driving board for driving the second electrodes by control of the control board.

32. The plasma display of claim 31, wherein a cell corresponds to an intersection of a respective first electrode, second electrode and third electrode, and
the first driving board and the second driving board sustain-discharge turn-on cells to display the image after setting turn-off cells among the turn-on cells through a discharge.
